(19) United States
(12) Patent Application Publication
(10) Pub. No.: US 2017/0244781 A1
(43) Pub. Date: Aug. 24, 2017

(54) ANALYSIS FOR MULTI-NODE COMPUTING SYSTEMS

(71) Applicant: HEWLETT PACKARD ENTERPRISE DEVELOPMENT LP, Houston, TX (US)

(72) Inventors: Andrew A. WALTON, Roseville, CA (US); Timothy F. FORELL, Palo Alto, CA (US); Zhikui WANG, Palo Alto, CA (US)

(73) Assignee: HEWLETT PACKARD ENTERPRISE DEVELOPMENT LP, Houston, TX (US)

(21) Appl. No.: 15/500,048

(22) PCT Filed: Oct. 31, 2014
(86) PCT No.: PCT/US2014/063311

§ 371 Date: Jan. 28, 2017

(51) Int. Cl. H04L 29/08

(52) U.S. Cl. CPC H04L 67/10

(57) ABSTRACT

A computing device includes at least one processor and an analysis module. The analysis module is to monitor status information for a first set of compute nodes. The analysis module is also to receive a level-one conclusion from a second manager node, wherein the level-one conclusion is generated by the second manager node based on at least in part on status information for a second set of compute nodes. The analysis module is also to generate a level-two conclusion based on the level-one conclusion, where the manager node, the first set of compute nodes, the second manager node, and the second set of compute nodes are included in a multi-node computing system.

### BACKGROUND

Some computing systems include a group of nodes working together as a single system. Such systems may be referred to as “multi-node computing systems.” Each node can be a computing device capable of functioning as an independent unit. The nodes may be interconnected to share data and/or resources. In addition, the nodes may communicate by passing messages to each other.

### BRIEF DESCRIPTION OF THE DRAWINGS

Some implementations are described with respect to the following figures.

FIG. 1 is a schematic diagram of an example multi-node system, in accordance with some implementations.

FIG. 2 is a schematic diagram of an example compute node, in accordance with some implementations.

FIG. 3 is a schematic diagram of an example manager node, in accordance with some implementations.

FIG. 4 is a flow diagram of a process according to some implementations.

FIG. 5 is a flow diagram of a process according to some implementations.

### DETAILED DESCRIPTION

In a multi-node computing system, each node can be a computing device including hardware resources such as processor(s), memory, storage, etc. Further, each node can include software resources such as an operating system, an application, a virtual machine, data, etc. In some implementations, a multi-node computing system may be configured for use as a single computing device, or as multiple computing devices. For example, a cluster may utilize clustering middleware to orchestrate the activities of each node (e.g., assigning tasks of a single application for execution on different nodes).

In accordance with some implementations, techniques and/or mechanisms are provided to allow for federated analysis of nodes in a multi-node computing system. The system may be divided into sets of compute nodes, with each set having a manager node. The manager node may monitor status information for the set. The manager node may generate a conclusion based on the status information, and may broadcast the conclusion to other manager nodes. A receiving manager node can determine whether additional conclusions can be generated based on the received conclusion. The federated analysis of information may enable a scalable management of systems including large numbers of nodes. Further, some implementations may enable monitoring of both hardware and software, and may support heterogeneous nodes.

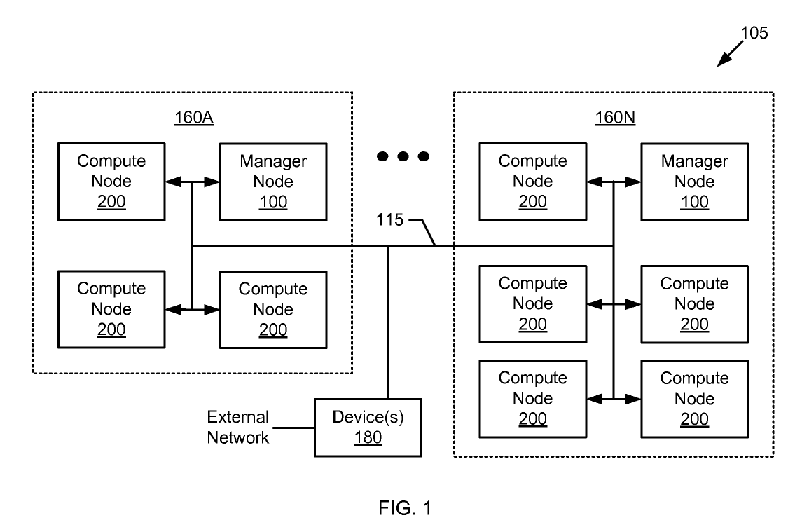

FIG. 1 is a schematic diagram of an example multi-node system 105, in accordance with some implementations. As shown, the multi-node system 105 can include any number of node sets 160A-160N. Each of the node sets 160A-160N may include a manager node 100 and any number of compute nodes 200. The nodes included in the node sets 160A-160N are coupled by a network 115 (e.g., a high-speed cluster interconnection, a system fabric, etc.). Further, the multi-node system 105 may include any number of other devices 180. For example, the device(s) 180 may include a network device to provide access to an external network, a power supply, a cooling system, and so forth.

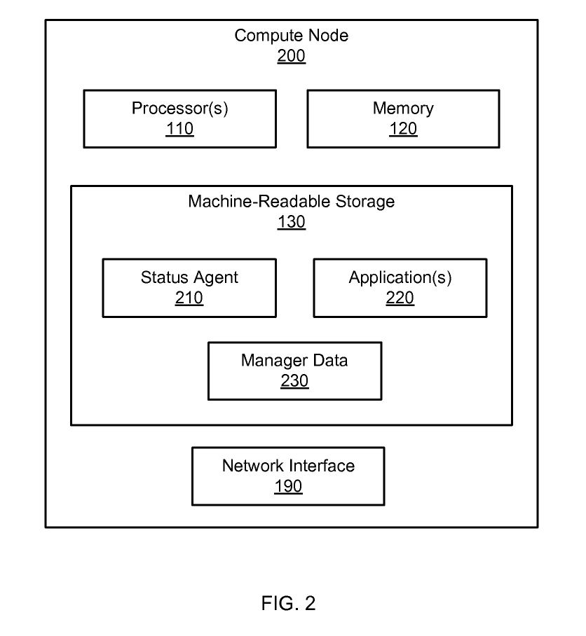

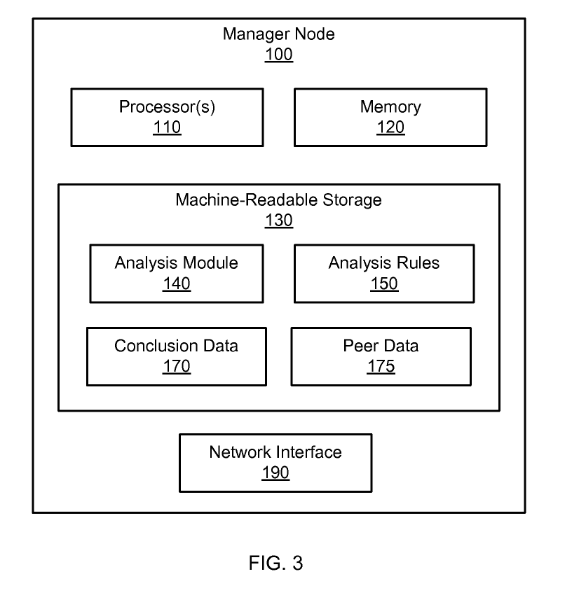

The node sets 160A-160N can each perform a separate task or function, can act together to perform a joint task or function, or any combination thereof. In some implementations, each manager node 100 may monitor and/or manage the compute nodes 200 included in the same node set. Further, in some implantations, a manager node 100 may monitor and/or manage any other device(s) 180. In addition, a manager node 100 may monitor and/or manage a set of logical functions across one or more compute nodes 200, across one or more sets of the node sets 160A-160N, and so forth. The configurations of the compute nodes 200 and the manager nodes 100 are described below with reference to FIGS. 2-3.

Referring now to FIG. 2, shown is a schematic diagram of a compute node 200, in accordance with some implementations. As shown, the compute node 200 can include processor(s) 110, memory 120, machine-readable storage 130, and a network interface 190. The processor(s) 110 can include a microprocessor, microcontroller, processor module or subsystem, programmable integrated circuit, programmable gate array, multiple processors, a microprocessor including multiple processing cores, or another control or computing device.

The memory 120 can be any type of computer memory (e.g., dynamic random access memory (DRAM), static random-access memory (SRAM), non-volatile memory (NVM), a combination of DRAM and NVM, etc.). The network interface 190 can provide inbound and outbound communication with the network 115. The network interface 190 can use any network standard or protocol (e.g., Ethernet, Fibre Channel, Fibre Channel over Ethernet (FCoE), Internet Small Computer System Interface (iSCSI), a wireless network standard or protocol, a proprietary network protocol, etc.).

The machine-readable storage 130 can include any type of non-transitory storage media such as hard drives, flash storage, optical disks, non-volatile memory, etc. As shown, in the compute node 200, the machine-readable storage 130 can include a status agent 210, application(s) 220, and manager data 230.

In some implementations, the status agent 210 can monitor information about the compute node 200. For example, the status agent 210 may monitor hardware status, operating system status, application information, network status and statistics, environmental measurements, power status, physical location, security settings, services, virtual machines, and so forth.

In some implementations, the manager data 230 may identify a manager node 100 (shown in FIG. 1) that is assigned to manage the compute node 200. The status agent 210 can send status messages to the identified manager node 100. These status messages can be based on the monitored information about the compute node 200. The status messages may be transmitted using the network interface 190.

In some implementations, the manager data 230 may be generated by broadcasting a request for manager information. For example, the status agent 210 can broadcast a request for manager nodes 100 to identify themselves, and can receive responses from manager nodes 100. The status agent 210 can use these responses to determine the closest manager node 100, and may store an identifier for the closes manager node 100 in the manager data 230.

Referring now to FIG. 3, shown is a schematic diagram of a manager node 100, in accordance with some implementations. As shown, the manager node 100 can include processor(s) 110, memory 120, machine-readable storage 130, and a network interface 190. Note that, while a manager node 100 and a compute node 200 may include similar components, implementations are not limited in this regard. For example, a manager node 100 may be implemented as a logically entity such as a virtual machine, a software program, and so forth.

As shown, the machine-readable storage 130 may include an analysis module 140, analysis rules 150, conclusion data 170, and peer data 175. In some implementations, the analysis module 140 can receive status information from associated compute nodes. For example, referring to FIGS. 1 and 3, the analysis module 140 in a manager node 100 may receive status messages from compute nodes 200 located in the same node set 160. The status messages may be received using the network interface 190. In addition, the analysis module 140 may receive information from any other source (e.g., information about network switches, power supplies, data center cooling, and so forth).

In some implementations, the analysis module 140 can evaluate the received status information using the analysis rules 150. If one or more of the analysis rules 150 applies to the received status information, the analysis module 140 can use the one or more analysis rules 150 to generate a level-one conclusion based on the received status information. For example, the analysis module 140 may use a rule-based inference to infer a level-one conclusion based on status messages. The level-one conclusion may be stored in the conclusion data 170. As used herein, the terms “primary conclusion” or “level-one conclusion” may refer to a conclusion that is based only on status information received from associated compute nodes.

In some implementations, the peer data 175 may enable the manager node 100 to identify other manager nodes 100 (referred to as “peer manager nodes”) included in a multi-node system. After generating a level-one conclusion, the analysis module 140 may use the peer data 175 to broadcast the level-one conclusion to one or more peer manager nodes 100. In some implementations, the peer data 175 may be generated by broadcasting a request for peer information. For example, the analysis module 140 can broadcast a request for each peer manager node 100 to identify itself, and can receive responses from peer manager nodes 100. The analysis module 140 may store identifiers for the peer manager nodes 100 in the peer data 175.

In some implementations, upon receiving a level-one conclusion from a peer manager node 100, the analysis module 140 can evaluate the received level-one conclusion using the analysis rules 150, and may thereby generate a level-two conclusion. The level-two conclusion can also be based in part on status information received by the analysis module 140 from associated compute nodes. Further, the level-two conclusion can be based on patterns of multiple level-one conclusions received from peer manager nodes 100. The generated level-two conclusion can be broadcast to peer manager nodes 100, and may also be stored in the conclusion data 170.

In some implementations, upon receiving a level-two conclusion from a peer manager node 100, the analysis module 140 can evaluate the received level-two conclusion using the analysis rules 150, and may thereby generate a second level-two conclusion. The second level-two conclusion can also be based in part on status information received from associated compute nodes. The second level-two conclusion can also be broadcast to peer manager nodes 100. As used herein, the terms “secondary conclusion” or “level-two conclusion” may refer to a conclusion that is based at least in part on another conclusion (i.e., a level-one conclusion, another level-two conclusion, multiple conclusions).

In some implementations, a level-two conclusion may be more accurate than a previous conclusion. For example, assume that a first manager node 100 receives status information from a compute node 200 that indicates that a first network device is unresponsive, and thus the first manager node 100 generates a level-one conclusion that a first network device is in an error state. Assume further that a second manager node 100 receives the level-one conclusion, and also receives status information from a different compute node 200 that indicates that that a second network device is also unresponsive. Finally, assume that the second manager node 100 generates a level-two conclusion that, because the first and second network devices are both unresponsive, the root cause is actually a failure in a power supply that feeds both the first and second network devices. Accordingly, in this example, the level-two conclusion is more accurate than the level-one conclusion, and thus may enable a more appropriate remedial action to be identified.

In some implementations, the analysis module 140 can determine whether a received conclusion is a global conclusion. As used herein, the term “global conclusion” may refer to a conclusion from which no further conclusion can be drawn based on the analysis rules 150. A global conclusion may involve determining that all of the possible conclusions have been drawn from both the data received from managed nodes and conclusions received from other manager nodes. For example, the analysis module 140 may determine that none of the analysis rules 150 apply to a received conclusion, and may thereby determine that it is a global conclusion. A global conclusion may be a level-one conclusion or a level-two conclusion.

In some implementations, the analysis module 140 can perform one or more actions based on a global conclusion. For example, in response to a global conclusion, the analysis module 140 can send a notification to a supervisor (e.g., a human analyst or management software), can control the power state of the manager node 100 or a compute node 200 (e.g., shut down the node, turn on/off a processor or core of the node, adjust clock speed and/or voltage, etc.), can add/remove a compute node 100 from a node set 160, can control a network device 180, can reboot the manager node 100 or a compute node 200, can trigger diagnostic or monitoring routines, and so forth.

In some implementations, a first manager node 100 may broadcast a level-one conclusion, and may wait for a defined time period to determine whether a level-two conclusion is generated by another manager node 100 based on (or otherwise related to) the level-one conclusion. For example, if no level-two conclusion is generated within the time period, the first manager node 100 may determine that the level-one conclusion is a global conclusion. In another example, a handshake may be performed between the manager nodes 100 to indicate that all of the conclusions from other manager nodes 100 have been processed. Each manager node 100 may broadcast that it has no new conclusions.

In some implementations, multiple manager nodes 100 can coordinate actions performed in response to conclusions. For example, each manager node 100 can wait until a single manager node 100 determines a global solution before taking any action (e.g., notifying a supervisor). Once the global solution is determined, the single manager node 100 may take the action of sending a message to a supervisor. In this manner, the supervisor does not receive multiple messages from different manager nodes 100 that are all directed to the same root cause. Accordingly, the supervisor is not overwhelmed by redundant or conflicting information, and may be able to more accurately evaluate the situation.

In some implementations, coordinating actions with other manager nodes 100 may involve storing multiple related conclusions in the conclusion data 170. Determining whether conclusions are related may be based on any information associated with the conclusions. For example, the analysis module 140 may determine that conclusions are related because they are associated with an affected device or component. In another example, the analysis module 140 may determine that conclusions are related because they are associated with the same physical or virtual location. In still another example, the analysis module 140 may determine that conclusions are related because they are both associated with the same application or virtual machine.

In some implementations, the manager nodes 100 may re-assign the compute nodes 200 among themselves. For example, a compute node 200 that is assigned to a first manager node 100 that has a relatively heavy load (e.g., a large number of incoming status messages, a large number of corrective actions to be performed, etc.) may be re-assigned to a second manager node 100 that has a relatively light load.

In some implementations, in the event that a compute node 200 is rebooted, the manager node 100 can detect the reboot and inform a supervisor about the problem, including which workloads are affected. An application may use a master failover protocol to handle a failure of a compute node 200 that is coordinating work among other compute nodes 200. The application can report which compute node 200 is acting as the master for the application. Further, a failover process may be performed for the manager nodes 100. For example, if the status agent 210 does not get an acknowledgement from the manager node 100 that it is sending data to, it can then direct the information to a different manager node 100. In another example, the analysis module 140 may also be able to trigger an action (e.g., a virtual machine migration) when problems with the system fabric might impact the performance of the compute node 200 running the master application. In still another example, the analysis module 140 may also enable the application to select an appropriate compute node 200 on which to replicate data.

In some implementations, the analysis module 140 may include an Application Programming Interface (API) for external system management systems. Examples of systems management services include deployment, configuration, booting, monitoring, flexing, etc. Such services may be provided as in-band or out-of-band management services. The API can enable an external system management system to receive conclusions from a manager node 100, and to interact with a manager node 100 to perform a corrective action.

In some implementations, the analysis module 140 may provide a user interface to view status information and/or conclusion of the multi-node system. For example, a system operator can log into a user interface via a webpage provided by a manager node 100. Because each manager node 100 can receive conclusions about the system from other manager nodes 100, any manager node 100 may enable access to information about the state of the entire multi-node system. Further, any manager node 100 can broadcast a request for system state information from other manager nodes 100.

In some implementations, the analysis module 140 may enable tracking of performance data over time, and may report cases where system performance changes rapidly. The analysis module 140 can then correlate any conclusions that have been broadcast to determine whether those conclusions are relevant to the performance change. The analysis module 140 can also send the received status messages to a storage location for further analysis (e.g., human analysis, machine learning analysis, etc.) to develop new analysis rules 150. Over time, the new analysis rules 150 can be broadcast back to the manager nodes 100.

In some implementations, the analysis rules 150 can be tailored to the workload running on the system. For example, new analysis rules 150 can be developed based on an analysis of how application performance is impacted by system configuration. Once a preferred configuration is identified for particular workload, new analysis rules 150 can be created to warn system operators when a workload is running on a less than ideal configuration. This type of analysis may also help system operators to predict performance problems when a failure occurs.

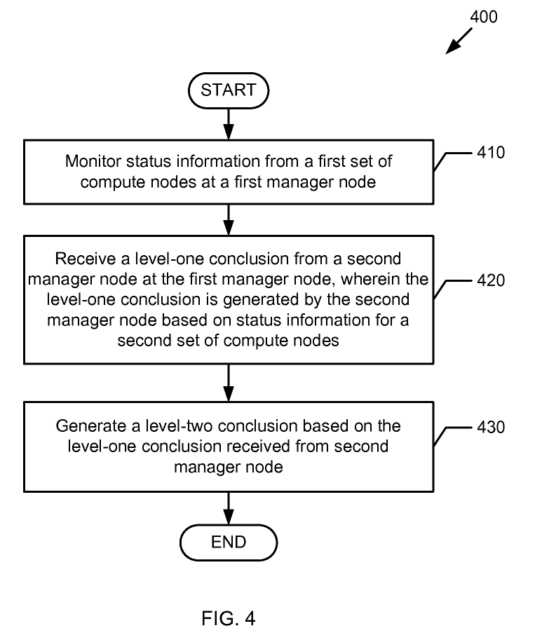

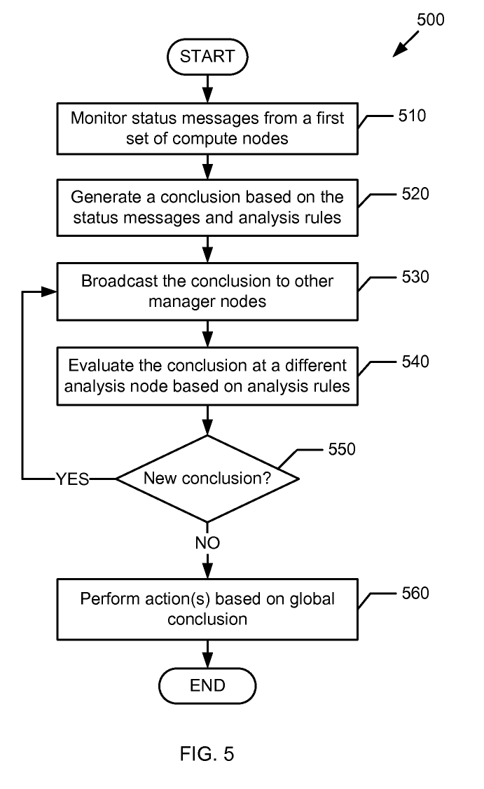

Various tasks of the analysis module 140 are discussed below with reference to FIGS. 4-5. Note that any of the features described herein in relation to the analysis module 140 can be implemented in any suitable manner. For example, any of these features can be hard-coded as circuitry in the analysis module 140. In other examples, the machine-readable storage 130 can include instructions that can be loaded and executed by the processor(s) 110 and/or the analysis module 140 to implement the features of the analysis module 140 described herein. In further examples, all or a portion of the machine-readable storage 130 can be embedded within the analysis module 140. In still further examples, analysis instructions can be stored in an embedded storage medium of the analysis module 140, while other information is stored in the machine-readable storage 130 that is external to the analysis module 140.

Referring now to FIG. 4, shown is a process 400 for federated node analysis, in accordance with some implementations. The process 400 may be performed by the processor(s) 110 and/or the analysis module 140 shown in FIG. 3. The process 400 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1-3, which show examples in accordance with some implementations. However, other implementations are also possible.

At 410, status information from a first set of compute nodes is monitored at a first manager node. For example, referring to FIG. 1, the manager node 100 of node set 160A may monitor status messages from the compute nodes 200 included in the node set 160A.

At 420, a level-one conclusion from a second manager node is received at the first manager node, where the level-one conclusion is generated by the second manager node based on status information for a second set of compute nodes. For example, referring to FIG. 1, the manager node 100 of node set 160A may receive a level-one conclusion generated by the manager node 100 of the node set 160B. In some implementations, the level-one conclusion may be based on status messages from the compute nodes 200 included in the node set 160B. The level-one conclusion may also be based on the analysis rules 150 (shown in FIG. 3). For example, the level-one conclusion may be generated by evaluating the analysis rules 150 using the status messages from the compute nodes 200 included in the node set 160B.

At 430, a level-two conclusion is generated by the first manager node based on the level-one conclusion received from second manager node. For example, referring to FIG. 1, the manager node 100 of node set 160A may generate a level-two conclusion based on the level-one conclusion received from the manager node 100 of the node set 160B. In some implementations, the level-two conclusion may also be based on status information and analysis rules 150 (shown in FIG. 3). Further, the level-two conclusion may also be based on stored conclusion data 170 (shown in FIG. 3). For example, the level-two conclusion may be generated by evaluating the analysis rules 150 using the level-one conclusion, the conclusion data 170, and/or status messages from the compute nodes 200 included in the node set 160A. After 430, the process 400 is completed.

Referring now to FIG. 5, shown is a process 500 for federated node analysis, in accordance with some implementations. The process 500 may be performed by the processor(s) 110 and/or the analysis module 140 shown in FIG. 3. The process 500 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 500 may be described below with reference to FIGS. 1-3, which show examples in accordance with some implementations. However, other implementations are also possible.

At 510, a first manager node monitors status messages from a first set of compute nodes. For example, referring to FIG. 1, the manager node 100 of node set 160A may monitor status messages from by the compute nodes 200 included in the node set 160A.

At 520, the first manager node generates a conclusion based on the status messages and analysis rules. For example, referring to FIG. 3, the analysis module 140 may generate a level-one conclusion based on received status messages and the analysis rules 150.

At 530, the first manager node broadcasts the generated conclusion to one or more other manager nodes. For example, referring to FIG. 3, the manager node 100 may broadcast the level-one conclusion to peer manager nodes 100 using the network interface 190. In some embodiments, the peer manager nodes 100 may be identified using the stored peer data 175.

At 540, the conclusion is received at a different manager node, and is evaluated using the analysis rules. For example, referring to FIG. 3, a peer manager node 100 may receive the level-one conclusion using the network interface 190, and may evaluate the analysis rules 150 using the received level-one conclusion. In some embodiments, the analysis rules 150 are copied to each manager node 100.

At 550, a determination is made about whether evaluating the received conclusion using the analysis rules results in a new conclusion. For example, referring to FIG. 3, the analysis module 140 may determine whether evaluating the analysis rules 150 using the received level-one conclusion results in a level-two conclusion.

If it is determined at 550 that evaluating the received conclusion using the analysis rules results in a new conclusion, then the process 500 returns to 530 to broadcast the new conclusion to other manager nodes. The new conclusion is evaluated by the other manager nodes at 540, and at 550, a determination is made about whether evaluating the new conclusion using the analysis rules results in yet another new conclusion. The loop including 530, 540, and 550 may be repeated while new conclusions are generated.

If it is determined at 550 that evaluating a conclusion using the analysis rules does not results in a new conclusion, then at 560, one or more actions can be performed based on the global conclusion (i.e., the last conclusion to be evaluated using the analysis rules). For example, referring to FIG. 3, the analysis module 140 may determine that evaluating the analysis rules 150 using a received level-two conclusion does not result in any additional conclusions, and may thus determine that the received level-two conclusion is the global solution. Further, the analysis module 140 may perform an action based on the global conclusion. For example, the analysis module 140 may send a notification to a supervisor, modify a power state, modify a device configuration, set a control parameter, reconfigure a node set, shutdown or reboot a compute node, load a software image on a compute node, reconfigure network settings, and so forth. After 560, the process 500 is completed. Note that, while FIGS. 1-5 show example implementations, other implementations are possible.

In accordance with some implementations, a federated analysis system may enable scalable management of large numbers of nodes. Multiple manager nodes 100 may monitor data and generate conclusions in a distributed fashion across a multi-node system. Further, an iterative process of generating conclusions across manager nodes 100 may provide globally optimized analysis results. Some implementations may enable monitoring of both hardware and software, and may support heterogeneous nodes.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; non-volatile memory (NVM), magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A manager node comprising:
at least one processor;
an analysis module executable on the at least one processor to:
monitor status information for a first set of compute nodes;
receive a level-one conclusion from a second manager node, wherein the level-one conclusion is generated by the second manager node based on at least in part on status information for a second set of compute nodes; and
generate a level-two conclusion based on the level-one conclusion received from the second manager node, wherein the manager node, the first set of compute nodes, the second manager node, and the second set of compute nodes are included in a multi-node computing system.

2. The manager node of claim 1, further comprising:
a machine readable storage device to store a plurality of analysis rules,
wherein the analysis module is to generate the level-two conclusion using the plurality of analysis rules.

3. The manager node of claim 2, wherein the analysis module is further to:
generate, using the plurality of analysis rules, a different level-one conclusion based on the status information for the first set of compute nodes; and
broadcast the different level-one conclusion to a plurality of other manager nodes.

4. The manager node of claim 2, wherein the analysis module is further to:
receive a second level-two conclusion from a third manager node;
determine whether at least one of the plurality of analysis rules applies to the second level-two conclusion; and
in response to a determination that at least one of the plurality of analysis rules applies to the second level-two conclusion, generate a third level-two conclusion based on the second level-two conclusion and the at least one of the plurality of analysis rules.

5. The manager node of claim 4, wherein the analysis module is further to:
in response to a determination that none of the plurality of analysis rules apply to the second level-two conclusion:
identify the second level-two conclusion as a global conclusion; and
determine whether any actions are to be performed in response to the global conclusion.

6. The manager node of claim 1, wherein the status information for the first set of compute nodes is sent only to the manager node, and wherein the status information for the second set of compute nodes is sent only to the second manager node.

7. The manager node of claim 1, wherein the status data comprises at least one of hardware status, error data, performance data, and application data.

8. A method comprising:
generating a primary conclusion at a first manager node, wherein the first manager node is associated with a first set of compute nodes;
broadcasting the primary conclusion from the first manager node to a set of manager nodes including a second manager node, wherein the second manager node is associated with a second set of compute nodes;
generating, at the second manager node, a secondary conclusion based at least on the primary conclusion, wherein the first manager node, the first set of compute nodes, the second manager node, and the second set of compute nodes are included in a multi-node computing system.

9. The method of claim 8, wherein generating the secondary conclusion comprises evaluating the primary conclusion using a first set of analysis rules, wherein the first set of analysis rules is stored on the second manager node.

10. The method of claim 9, further comprising:
broadcasting the secondary conclusion from the second manager node to at least a third manager node of the set of manager nodes;
receiving the secondary conclusion at the third manager node; and
generating, at the third manager node, a different secondary conclusion based at least on the received secondary conclusion and a second set of analysis rules, wherein the second set of analysis rules is stored on the third manager node, wherein the first set of analysis rules and the second set of analysis rules are distributed copies of a plurality of analysis rules.

11. The method of claim 8, further comprising:
receiving, at a fourth manager node, the secondary conclusion from the second manager node;
determining that the secondary conclusion is a global conclusion; and
performing at least one action in response to the global conclusion.

12. The method of claim 8, further comprising:
broadcasting, by a first compute node of the first set of compute nodes, a request for management identification; and
in response to the request for management identification, sending, by the first manager node, a management notification to the first compute node, wherein the management notification indicates that the first compute node is to send all status messages to the first manager node.

13. An article comprising at least one non-transitory machine-readable storage medium storing instructions that upon execution cause at least one processor to:
receive, at a first manager node, status messages from a first set of compute nodes;
receive, at the first manager node, a level-one conclusion from a second manager node, wherein the level-one conclusion is generated by the second manager node, wherein the second manager node is to receive status messages from a second set of compute nodes; and
generate, at the first manager node, a level-two conclusion based on a plurality of analysis rules and the level-one conclusion received from the second manager node, wherein the first manager node, the first set of compute nodes, the second manager node, and the second set of compute nodes are included in a multi-node computing system.

14. The article of claim 13, wherein the instructions further cause the processor to:
generate, using the plurality of analysis rules, a second level-one conclusion based on the status messages from the first set of compute nodes; and
broadcast the second level-one conclusion to a plurality of other manager nodes.

15. The article of claim 13, wherein the instructions further cause the processor to:
broadcast a request for peer identification; and
receiving a plurality of peer notifications, wherein each of the plurality of peer notifications identifies a unique manager node and is generated in response to the request for peer identification.
